(19) United States
(12) Patent Application Publication
(10) Pub. No.: US 2022/0027874 A1
(43) Pub. Date: Jan. 27, 2022

(54) AUTONOMOUS MOBILE BANKING FOR DISASTER-RELIEF

(71) Applicant: Wells Fargo Bank, N.A., San Francisco, CA (US)

(72) Inventors: H. Brock Kolls, Alpharetta, GA (US); Timothy A. Gates, Ewing, NJ (US); Thomas Charles Evans, Edina, MN (US)

(21) Appl. No.: 15/710,998

(22) Filed: Sep. 21, 2017

(51) Int. Cl. G06Q 20/10; G06Q 20/32; G05D 1/00

(52) U.S. Cl. CPC G06Q 20/1085; G05D 1/0027; G05D 1/0088; G06Q 20/325

(57) ABSTRACT

Mobile banking systems and methods for providing disaster-relief in an area impacted by a disaster event include a plurality of autonomous mobile banking units (MBU), each with an autonomous vehicle including an automated teller machine (ATM). Data is received from a plurality of data sources and analyzed to determine a plurality of locations for deployment of the plurality of MBUs, respectively. The plurality of MBUs are autonomously deployed to the respective plurality of locations in response to the event.

### BACKGROUND

Automated banking services are becoming more and more common. For example, banking customers may conduct many banking transactions remotely from a permanent, physical “brick and mortar” bank building. Automated teller services machines (ATM), home computers, mobile devices, etc. are all employed to conduct remote banking transactions. As a result, face-to-face cash transactions are less frequent. Thus, if events occur that disrupt digital communications, banking and other business and personal transactions become more difficult. For instance, during a disaster event such as a storm, flood, fire, etc., normal business and communication services may be interrupted. Moreover, when communications are interrupted, other vital human needs such as medical treatment, housing, food and water provisions, etc. may also be interrupted.

### SUMMARY

In accordance with certain aspects of the present disclosure, autonomous mobile banking systems and methods for providing disaster-relief in an area impacted by a disaster event include a plurality of autonomous mobile banking units (MBU), each of which have an autonomous vehicle including an automated teller machine (ATM). Computer-readable data storage media accessible by a processor store program instructions that configure the processor to implement various disclosed operations. In some examples, data are received from a plurality of data sources. The data are analyzed prior to the disaster event, and based on this analysis, a plurality of locations for deployment of the plurality of MBUs, respectively, is determined. The plurality of MBUs are autonomously deployed to the respective plurality of locations in response to the event.

In accordance with other examples, data are received from a plurality of data sources. The data are analyzed and a plurality of locations for deployment of a plurality of MBUs, respectively, are determined based on the data analysis. The MBUs are autonomously deployed to the respective plurality of locations in response to the event. Wireless communication is established between a first MBU and a second MBU of the plurality of MBUs. The first one of the plurality of MBUs is moved to an alternative location while maintaining the wireless communication with the second MBU.

In accordance with further examples, data are received from a plurality of data sources and analyzed prior to and after a disaster event. A plurality of locations for deployment of a plurality of MBUs, respectively, are determined based on the analysis of data prior to the event. Based on the analysis of data after the event, an alternative location for deployment of a first MBU of the plurality of MBUs is determined.

### DESCRIPTION OF THE DRAWINGS

FIG. 1 is a block diagram illustrating an example of an autonomous mobile banking system for providing disaster-relief in an area impacted by a disaster event, in accordance with aspects of the present disclosure.

FIG. 2 is a block diagram conceptually illustrating aspects of an example of an autonomous vehicle in accordance with aspects of the present disclosure.

FIG. 3 is a block diagram conceptually illustrating various data sources received by the example system shown in FIG. 1.

FIG. 4 is a process flow diagram illustrating an example of an autonomous mobile banking method for providing disaster-relief in an area impacted by a disaster event, in accordance with aspects of the present disclosure

FIG. 5 is a block diagram conceptually illustrating an example of the system of claim 1 deployed in an area affected by a disaster event.

FIG. 6 is a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. The following detailed description, therefore, is not to be taken in a limiting sense.

The present disclosure generally relates to disaster relief in an area impacted by a disaster event sufficient to interrupt normal business and communication services. Such disasters can include storms, hurricanes, floods, fires, and the like. Autonomous mobile banking units (MBU), which include an autonomous vehicle, are equipped so as to conduct automated banking services, such as with an automated banking teller machine (ATM). As used herein, an autonomous vehicle refers to a vehicle that can detect its surroundings and navigate with little or no human input. Techniques such as radar, a global positioning system (GPS) and computer vision can be used to navigate the autonomous vehicle. Machine learning and predictive analytics in combination with a fleet of the autonomous MBUs are combined to service groups of customers in an area that has been impacted by a disaster event.

During and/or following a disaster event, residents in and around the affected area are often cut off from being able to communicate with loved ones and may need banking services for repairing homes and possessions, and meeting basic needs such as food and water and shelter. Banking services can include cash deposits and withdrawals for individual customers. Additional services provided by financial institutions during and following disaster events could include distributing or revaluing prepaid cards with funds to individual customers, as well as to non-profit organizations such as the Red Cross and other organizations for distribution as necessary. Moreover, in accordance with aspects of the present disclosure, MBUs may be deployed to provide services in addition to traditional banking services, such as facilitating communication and basic internet access.

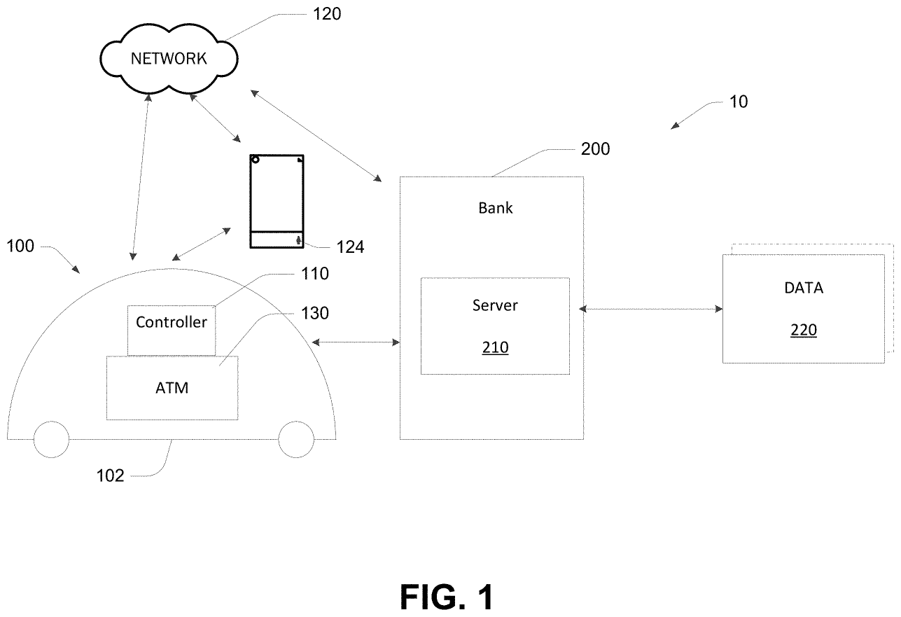

FIG. 1 illustrates aspects of an example autonomous mobile banking system 10. The system 10 has a plurality of MBUs 100 (for sake of simplicity, a single MBU 100 is shown in FIG. 1). The MBU 100 includes an autonomous vehicle 102 and a controller 110, which could be implemented by any suitable computing device that including a processor, memory, and associated components. The autonomous vehicle 102 further houses an ATM 130. The MBU 100 could include additional components as necessary. For instance, in some implementations the MBU 100 includes a camera, allowing the MBU to broadcast images of its area and surroundings. Such images could be useful to various organizations for assessing the impacted area.

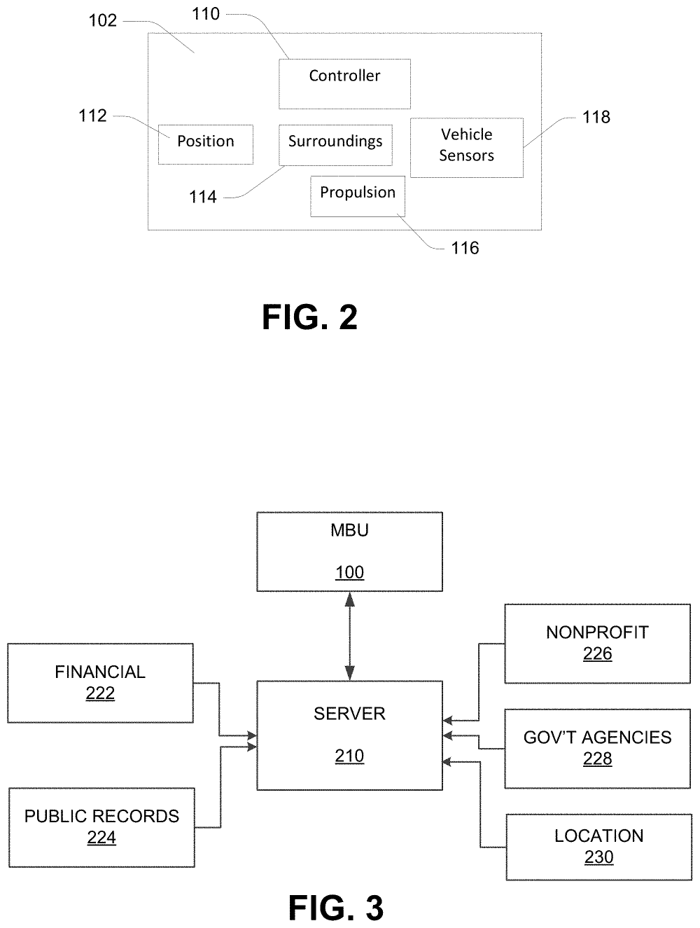

FIG. 2 is a block diagram illustrating aspects of an example autonomous vehicle 102 of the MBU 100, which includes the controller 110 configured to operate the autonomous vehicle 102. The example autonomous vehicle 102 is a self-driving vehicle, which has enhanced security features for safely transporting the ATM 130 and other personnel and items transported thereby. The controller 110 provides instructions in the form of control signals (such as driving and stopping signals) to the appropriate components of the autonomous vehicle 102. The controller 110 includes a positioning device 112 that can receive and transmit position data to the controller 110. The location of the vehicle 100 at any given time can be determined by the positioning device 112 or another appropriate positioning system. Examples of such positioning devices 112 include GPS systems and devices. The vehicle controller 110 further includes a surroundings detection system 114 configured to detect the surroundings of the vehicle 100 by appropriate detection systems such as radar, laser light, GPS, odometry, computer vision, etc. The controller 110 is configured to interpret location, surroundings, and other sensory information such as from various vehicle sensors 118 to identify appropriate navigation paths, as well as obstacles and relevant driving information, and output control signals to a propulsion system 116 that includes appropriate components (energy, propulsion, transmission, steering, etc.) for driving the vehicle 102.

Referring back to FIG. 1, a server computer 210 communicates with the autonomous vehicle 102 and the ATM 130 of the MBU 100 via a network such 120 such as the internet. Additionally, in some examples, the server 210 is configured to communicate wirelessly directly with the MBU 100 via any suitable secure communications scheme. In the illustrated example, the server 210 is a server computer at a fixed location of a bank or other financial institution. A fixed location as used herein refers to a fixed, generally non-mobile permanent structure, such as a typical bank building, as opposed to a readily movable structure such as a vehicle or trailer intended for non-permanent geographical placement, for example. In some implementations, some functions of the server computer 210 are implemented by the controller 110.

The server computer 210 is accessible by the ATM 130, and may process various transactions via the ATM 130. A user device 124, such as a customer's smart phone, may also facilitate customer transactions conducted via the MBU 100. Information relating to financial transactions from the ATM 130, as well as other ATM and autonomous vehicle information may be transmitted to the server computer 210, either directly or via the network 120. Financial information and other information generated by the server computer 210 may also be transmitted to the autonomous vehicle 102 and the ATM 130 of the MBU 100.

Both the controller 110 and the server computer 210 include a processor and a memory accessible by the processor storing program instructions that configure the computer corresponding computers to implement various processes disclosed herein. In some examples, the server 210 can be one of a network of servers (e.g., a “cloud”) of the system 10. Further, each server in the network of servers can be adapted to perform a specific function or functions on behalf of the system 10. Although specific functionalities will be attributed to the server 210 (and/or controller 110) in this disclosure, it should be appreciated that the same functionalities can be divided among a network of interconnected servers. Thus, throughout this disclosure, the server 210 can alternatively be understood as a single server or a network of servers.

The server computer 210 receives data 220 via various devices and databases. FIG. 3 illustrates examples of various data types 220, including financial data 222 that may include information from customer accounts local to the bank 200, and/or financial data from external financial institutions or other financial networks. Various public record data 224 may be received, such as real estate information, birth and death information, etc. Additionally, the server 210 may communicate with databases at nonprofit organizations 226, such as the Red Cross or other disaster relief agencies, as well as government agencies such as the Federal Emergency Management Agency (FEMA), law enforcement agencies, National Oceanic and Atmospheric Administration (NOAA), etc. Still further, the server may receive location data 230, such as customer location data provided by, for example, GPS locating applications of user devices 124.

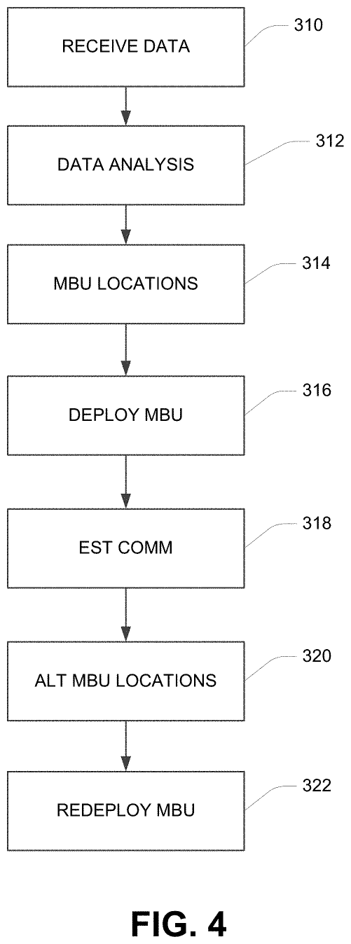

FIG. 4 illustrates an example of processes implemented by various components of the system 10. In particular, the illustrated process provides systems and methods for providing disaster-relief in an area impacted by a disaster event. For instance, at operation 310, the server 210 receives data 222 from various data sources and databases, and the data are analyzed as shown in operation 312. Based on the data analysis, locations for deployment of the respective MBUs 100 are determined at operation 314.

In response to a disaster event, MBUs 100 are autonomously deployed to the respective locations in operation 316. As used herein, autonomously deployed refers to moving the MBUs 100 to their respective locations to provide financial and other services during or following a disaster event, without a human driver operating the MBUs 100. Instead, the autonomous vehicle 102 is operated to deploy the ATM 130 to the predetermined locations without necessarily requiring a human driver. For instance, this allows deploying manpower to other locations where disaster relief is required. Moreover, deployment locations and routes to such locations for the MBUs could be impacted by the disaster event, such that conditions could be unsafe for a human operator.

In some examples, communications between two or more of the MBUs is established in operation 318. For instance, a wireless mesh network may be established via the MBUs to allow customers to communicate for banking and other purposes following the disaster event. Generally, a mesh network is a network topology in which each node (the deployed MBUs) relays data for the network. All mesh nodes cooperate in the distribution of data in the network. It can be applied to both wired and wireless networks. Such mesh networks could be implemented by any suitable form of network topology, and are thus particularly well suited for use following a disaster event.

Typically, mesh networks are ad hoc networks, and are continuously self-configuring. As such, each MBU 100 in the network may move independently in any direction as dictated by disaster relief needs. In some examples, the MBU nodes of the network are moved so as to maintain the network, such as by limiting movement of particular MBUs 100, and or configuring the MBUs to change its links to other MBUs or other devices as necessary to maintain the mesh network.

In the illustrated example, the data analysis process 312 is used in a machine learning process to predict and determine the initial locations for deployment of the MBUs in response to the disaster event. In some implementations, the data analysis 312 continues during and after the disaster event, and may include continuously receiving and analyzing customer data, such as customer transaction and location data. Based on this and other data analysis, the MBU locations may be adjusted in real time, as required based on relief effort needs resulting from the disaster event, as shown in operation 320. At appropriate times, one or more of the MBUs 100 may be autonomously redeployed to the alternative locations in operation 322. As noted above, such movement of MBUs may be conducted so as to maintain the established communications network.

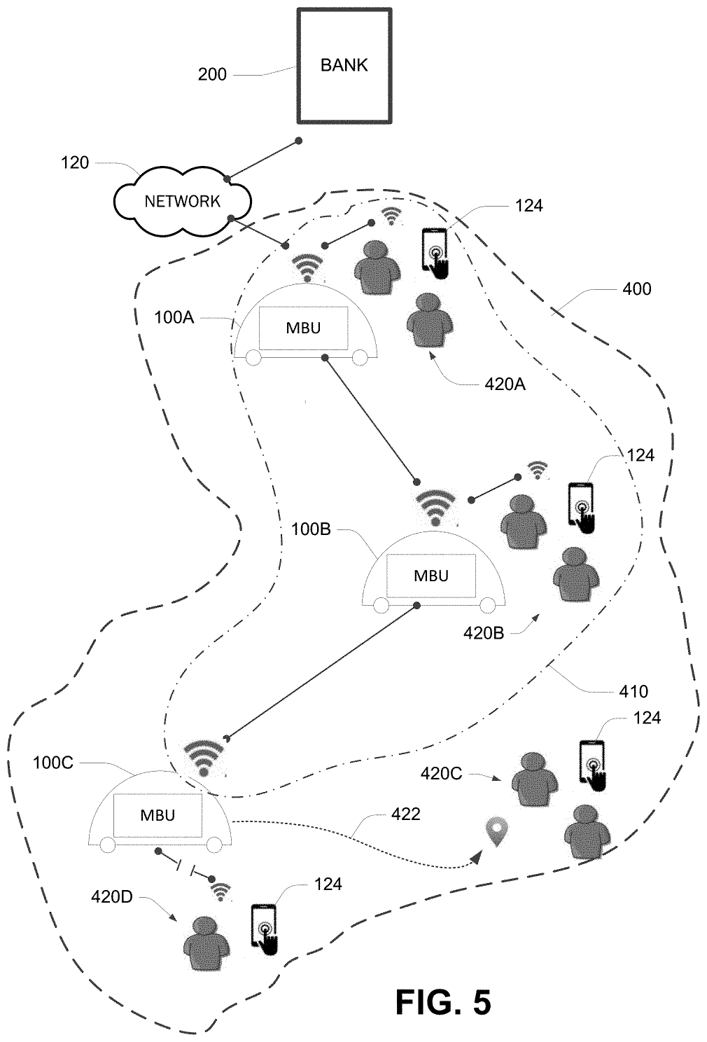

FIG. 5 is a block diagram illustrating further aspects of example systems and methods disclosed herein. As noted above, the disclosed system 10 is suited for deployment into a disaster zone 400 during or following a disaster event. Once it is safe to enter the disaster zone 400, a fleet of the autonomous MBUs, including MBUs 100A, 100B, 100C, are dispatched to form a financial-mesh-communication-network 410. Among other things, the network 410 may be employed to transact financial transactions and provide access to the internet 120 (or other network) for customers within the disaster zone 400.

In the illustrated example, the system 10 uses machine learning, based on previous (pre-disaster) data analysis. Such pre-disaster data may include, for example, customer transaction history to determine the initial geographic locations in which to deploy the MBUs 100. In FIG. 5, the MBUs 100A, 100B. 100C are deployed to serve groups of customers 420A, 420B, 420C, 420D.

Once the MBUs are initially deployed, the machine learning can continue continued data analysis, such as analysis of customer transactions that are being transacted within the disaster zone 400, and/or customer location information provided by GPS functions of user devices 124 to determine when and where the MBUs 100A, 100B, 100C should be geographically located.

Such data analysis and machine learning algorithms may, for example, divide the day into day parts (morning-noon-night, by the hour, day of week, etc.) to understand how and when the MBUs 100A, 100B, 100C should be relocated during the day. As example, if a particular retail establishment is operational following the disaster event, and is open from 9 am-5 pm, one of the MBUs could be located near the retail establishment during those hours. The same MBU could be redeployed to an alternative location after 5 pm.

The pre-disaster data analysis may also determine how many MBUs 100 to send into the disaster zone 400 to meet the transaction needs of the customers 420A, 420B, 420C, 420D. In the example of FIG. 5, the pre-disaster data analysis determined that the MBU 100A could meet the needs of the group of customers 420A, the MBU 100B could meet the needs of the group of customers 420B, and so on. As noted above, the MBUs 100 may be relocated as required, and could be moved to safe storage areas at night.

In the illustrated example, each of the MBUs 100A, 100B, 100C maintains wireless coverage with at least one other MBU to establish and maintain a reliable wireless network 410. In this regard, the area of the network 410 covers only a portion of the total disaster area 400. The size and shape of the coverage of the network 410 will typically change as the MBUs relocate 100A, 100B, 100C, depending on the size of the disaster area and the number of MBUs 100 available for deployment. Thus, where the disaster area 400 is relatively small, the entire disaster area 400 could be covered by the network 410, while in cases where the disaster area 400 geography is relatively large (or if parts are inaccessible to the MBUs), only a portion of the disaster area 400 may be coverable by the network 410 at a given time.

To provide regular, reliable communications services, in some implementations the data analysis includes considering maintaining the network 410 when determining alternative MBU locations. For instance, data such as the number of MBUs 100 available for deployment, population of the disaster area 400, network 410 constraints, etc. could be analyzed. Using more MBUs than necessary wastes resources, while too few MBUs spaced too far apart could result in network gaps, resulting in a potential loss of the network 410 and the associated customer service.

In some examples, the MBU deployment is determined based on balancing the size of the network 410 coverage in view of the size of the disaster area 400 and further in view of the location of the affected customer groups. In this manner, the network coverage may be minimized to increase network reliability and reduce the MBUa required to establish the mesh network, while covering the portion of the disaster area 400 where the majority of customers are located. Thus, the illustrated network area 410 could cover 50% of the disaster area 400, but 90% of the affected customers.

Thus, it could be possible that some customers do not have access to the network 410 at all times. For instance, if a customer 420D does not have wireless access, they can still use a user device 124 to generate a request for banking services and queue up the request and other emails, texts, and other messages in their device 124. As the MBU 100C moves along a route 422 and comes into proximity with the user device 124 of the customer 420D, wireless connection is reestablished (even briefly). At this time, the queued requests, messages, etc. can be communicated to the MBU 100C, and transmitted to the internet 120 via the network 410. Moreover, if the MBU 100C determines that the data received from the customer 420D includes a request for banking services, the autonomous vehicle 102 of the MBU 100C may be controlled to stop the MBU 100C to allow the customer 420D to conduct the requested transaction(s) using the ATM 130 of the MBU 420C and/or the wireless connectivity of the MBU 420C. Received data which are not banking requests can be forwarded across the network 410 to the internet 120 and on to their respective destinations.

As noted above, deployment locations and routes may be determined by data analysis, both before and after a disaster event. Further, the MBUs 100 are configured in some embodiments to communicate with each other and plan their movements. Thus, as discussed previously, MBUs 100A, 100B, 100C may be deployed and redeployed as needed to serve the customers 420A, 420B, 420C, and 420D. However, to maintain the reliability of the network 410 (no breaks or gaps), the MBU movement is coordinated. Accordingly, the MBUs 100A, 100B, 100C move synchronously such that the boundary of the network 410 could change shape, but remain intact within the disaster zone area 400. This synchronization may require a certain route to be taken by a given MBU, or one MBU may be required to stop or change speed in route to allow other MBUs to relocate before continuing to a destination.

As shown in FIG. 5, as MBU 100C moves along the route 422 towards customers 420C, it may have to stop in route and allow MBU 100A and/or MBU 100B to relocate before MBU 100C can continue to the location of the destination customers 420C. One or more of the server 210 of the bank 200 and/or the controllers 110 of the MBUs 100 may be so programmed to ensure the reliability and coverage of the network 410 is maintained.

In this manner, it may be possible for fewer MBUs 100 to service a larger disaster area 100 and more customers 420 by predicting or determining when and where financial transactions are likely to occur, and then moving in a synchronized fashion to serve a distributed population of customers 420. It also allows customers to reliably use the network 410 (and internet 120 connected thereto) as the MBUs 100 are in motion.

In further examples, as MBUs 100 move and relocate, they can broadcast an electronic message to the user devices 124 to inform the associated customers that an MBU is in their vicinity. Such a broadcast could be made by any suitable means, such as email, text, etc. The message can inform customers 420 when and where the MBU 100 will be located and invite the customers to conduct desired financial transactions, or use the associated wireless communications for other purposes. Still further, such messages could provide further information related to the disaster event. For example, the MBUs could broadcast a community message regarding found or missing persons, weather forecast information, relief information, etc. Since these messages are broadcast via moving MBUs, the number of message recipients may be maximized.

As noted above, the functions of the MBUs 100 are not necessarily limited to financial transactions. The MBUs 100 may be configured to provide additional relief services, providing meeting areas and safe zones where supplies could be distributed, user devices 124 could be charged, etc. For example, the MBUs may be configured so as to insure victims of the event periodically get some amount of an inventory of supplies, such as those provided by relief organizations. Additionally, any necessary mobile device applications could be distributed, and victims without access to user devices 124 could access financial and other services directly via the MBUs. Broadcasting messages to the user devices 124 informs customers 420 and others affected by the disaster event regarding available supplies, local merchants, etc.

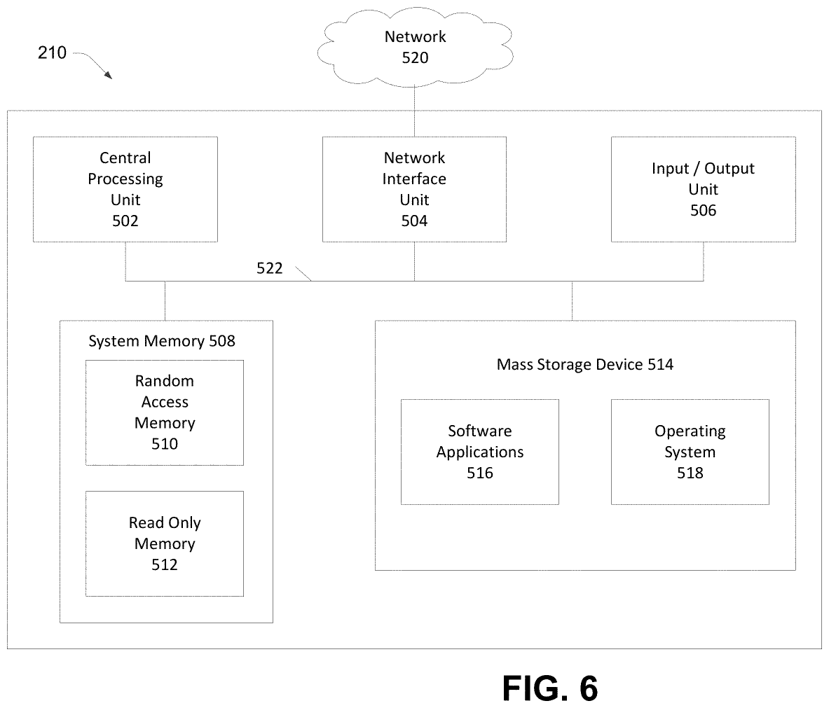

FIG. 6 schematically illustrates an example of the computer 210, which could be a server computer at a financial institution as discussed above. The controller 110 of the autonomous vehicle 102, as well as portions of the user device 124 and the ATM 130 could have similar structures. The computer 210 includes at least one processor (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the server computer 210, such as during startup, is stored in the ROM 512. The server computer 210 further includes a mass storage device 514. The mass storage device 514 is able to store software instructions and data. As noted above, the user accounts 106 could be stored in a database implemented by the mass storage device 512, and could further include additional databases implemented by other computer systems accessible by the server 210. A processor, system memory and mass storage device similar to that in FIG. 7 are also included in the controller 110.

The mass storage device 514 is connected to the CPU 502 through a mass storage controller (not shown) connected to the system bus 522. The mass storage device 514 and its associated computer-readable data storage media provide non-volatile, non-transitory storage for the server computer 210. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 210.

According to various embodiments of the invention, the server computer 210 may operate in a networked environment using logical connections to remote network devices through the network 520, such as a wireless network, the Internet, or another type of network. The server computer 210 may connect to the network 520 through a network interface unit 504 connected to the system bus 522. It should be appreciated that the network interface unit 504 may also be utilized to connect to other types of networks and remote computing systems. The server computer 210 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the server computer 210 can store software instructions and data. The software instructions include an operating system 518 suitable for controlling the operation of the server computer 210. The mass storage device 514 and/or the RAM 510 also store software instructions, that when executed by the CPU 502, cause the server computer 210 to provide the functionality of the server computer 210 discussed in this document. For example, the mass storage device 514 and/or the RAM 510 can store software instructions that, when executed by the CPU 502, cause the server computer 210 to implement the various processes described herein, among other things.

Although various embodiments are described herein, those of ordinary skill in the art will understand that many modifications may be made thereto within the scope of the present disclosure. For instance, examples related to home loans are included herein, though the disclosed systems and methods are also applicable to many other financial processes, such as personal and business loans, credit card accounts, home equity lines of credit, mortgage refinances, etc. Accordingly, it is not intended that the scope of the disclosure in any way be limited by the examples provided.

1. An autonomous mobile banking system for use in an area impacted by a disaster event, comprising:
a plurality of autonomous mobile banking units (MBUs), each of the MBUs including an autonomous vehicle including an automated teller machine (ATM);
a processor;
computer-readable data storage media accessible by the processor storing program instructions that configure the processor to:
(a) receive data from a plurality of data sources, the data including a size of the area impacted, a number of banking customers in the area impacted, and locations of the banking customers;
(b) analyze the data prior to the event;
(c) determine, based on the data analysis prior to the event, a minimum number of MBUs to drive to the impacted area and, for each of the minimum number of MBUs, an initial placement within the area impacted, the minimum number and the initial placements being determined to:
(i) provide a wireless mesh network, using the minimum number of MBUs, that defines a coverage area for which the wireless mesh network provides communications services; and
(ii) maximize a number of banking customers within the coverage area;
(d) establish direct wireless communication between the minimum number of MBUs such that each of the minimum number of MBUs operates as a node of the wireless mesh network; and
(e) autonomously drive each of the minimum number of MBUs to the respective initial placement in response to the event to establish the wireless mesh network having the coverage area within the area impacted by the disaster event.

2. The system of claim 1, wherein the processor is contained in at least one of the MBUs.

3. The system of claim 1, wherein the processor is contained in a server computer remote from the plurality of MBUs.

4. (canceled)

5. The system of claim 1, further comprising a fixed location of a financial institution in wireless communication with the mesh network.

6. The system of claim 1, wherein the program instructions further configure the processor to control the ATM of at least one of the MBUs to conduct a banking transaction.

7. The system of claim 6, wherein the program instructions further configure the processor to control the ATM of at least one of the MBUs to conduct a remote banking transaction with a customer via the wireless mesh network.

8-9. (canceled)

10. The system of claim 1, wherein the received data includes data regarding previous banking transactions.

11. The system of claim 1, wherein the received data includes data regarding customer locations.

12. (canceled)

13. A method for providing services in an area impacted by a disaster event, comprising:
(a) receiving data from a plurality of data sources, the data including a size of the area impacted, a number of banking customers in the area impacted, and locations of the banking customers;
(b) analyzing the data;
(c) determining, based on the analyzing, a minimum number of MBUs to drive to the impacted area and, for each of the minimum number of MBUs, an initial placement within the area impacted, each of the MBUs including an autonomous vehicle including an automated teller machine (ATM), the minimum number and the initial placements being determined to:
(i) provide a wireless mesh network, using the minimum number of MBUs, that defines a coverage area for which the wireless mesh network provides communications services; and
(ii) maximize a number of banking customers within the coverage area;
(d) establish direct wireless communication between the minimum number of MBUs such that each of the minimum number of MBUs operates as a node of the wireless mesh network; and
(e) autonomously driving each of the minimum number of MBUs to the respect initial placement in response to the event to establish the wireless mesh network having the coverage area within the area impacted by the disaster event.

14. The method of claim 13, further comprising establishing wireless communications between at least one of the minimum number of MBUs and a fixed location of a financial institution.

15-16. (canceled)

17. A control system for providing services in an area impacted by a disaster event, comprising:
a processor;
computer-readable data storage media accessible by the processor storing program instructions that configure the processor to:
(a) receive data from a plurality of data sources, the data including a size of the area impacted, a number of banking customers in the area impacted, and locations of the banking customers;
(b) analyze the data prior to the event;
(c) determine, based on the data analysis prior to the event, a minimum number of MBUs to drive to the area and, for each of the minimum number of MBUs, an initial placement within the area impacted, the minimum number and the initial placements being determined to:
(i) provide a wireless mesh network, using the minimum number of MBUs, that defines a coverage area for which the wireless mesh network provides communications services; and
(ii) maximize a number of banking customers within the coverage area;
(d) establish direct wireless communication between the minimum number of MBUs such that each of the minimum number of MBUs operates as a node of the wireless mesh network, and,
(e) autonomously drive each of the minimum number of MBUs to the respective initial placement in response to the event to establish the wireless mesh network having the coverage area within the area impacted by the disaster event.

18. The system of claim 17, wherein the program instructions further configure the processor to receive respective locations of available MBUs.

19. (canceled)

20. The system of claim 17, wherein the analyzed data includes customer location data.
